(19) United States
(12) Patent Application Publication
(10) Pub. No.: US 2024/0111349 A1
(43) Pub. Date: Apr. 4, 2024

(54) DATA CENTER POWER CONSUMPTION THROUGH MODULATION OF POWER SUPPLY UNIT CONVERSION FREQUENCY

(71) Applicant: Intel Corporation, Santa Clara, CA (US)

(72) Inventors: Sakthi Priyan B S, Bangalore (IN); Shashi Shekhar SINGH, BANGALORE (IN); Subhajit GHOSH, Bengaluru (IN); Ankita Vilas GAWADE, Pune (IN); Gokul SANKER V G, Kollam (IN); Mandar Chandrakant THORAT, Bengaluru (IN); Vikrant THIGLE, Bangalore (IN)

(21) Appl. No.: 18/537,740

(22) Filed: Dec. 12, 2023

(51) Int. Cl. G06F 1/28

(52) U.S. Cl. CPC G06F 1/28

(57) ABSTRACT

A method is described. The method includes receiving system level power information. The method includes causing a power supply unit's voltage conversion switching frequency to change based on the system level power information. The power supply unit supplies power to a system that includes at least a processor and memory. The system level power information describes power consumed by at least the processor and memory.

### BACKGROUND

As the performance of cloud computing, big data, artificial intelligence and other forms of large scale computing continues to expand, the electrical power consumption of the data centers that support large scale computing is likewise increasing. As such, data center operators are increasingly seeking ways to improve the efficiencies of their electrical power consumption.

### BRIEF DESCRIPTION OF FIGURES

FIG. 1 depicts a motherboard system;

FIG. 2 depicts a method performed by the motherboard system;

FIG. 3 depicts a power supply unit of the motherboard system of FIG. 1;

FIG. 4 depicts a motherboard system having a power supply unit capable of switching voltage conversion frequencies and a software platform capable of determining per virtual machine power consumption;

FIG. 5 depicts a data center;

FIG. 6a depicts a first view of an infrastructure processing unit;

FIG. 6b depicts a second view of an infrastructure processing unit.

### DETAILED DESCRIPTION

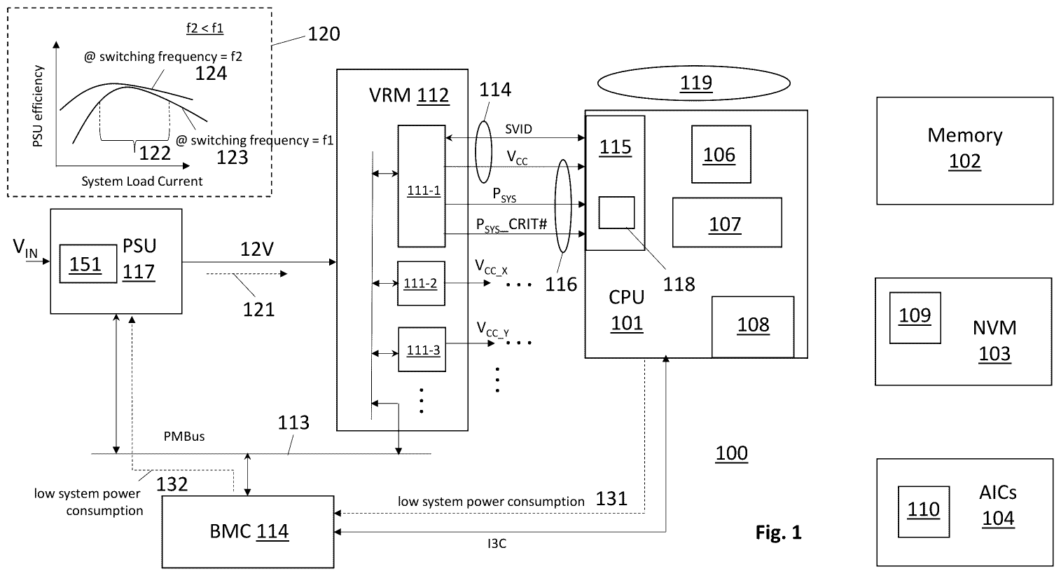

FIG. 1 shows an architecture for a motherboard system 100 (“motherboard”, “baseboard” and the like) and its power system. As observed in FIG. 1, the motherboard 100 includes at least one processor chip 101 and various supporting integrated circuits such as one or more memory modules 102 (e.g., one or more DRAM dual in-line memory modules (DIMMs) that are plugged into the motherboard), one or more non-volatile memory (NVM) devices 103 (e.g., flash memory chips and/or solid state drive (SSD) devices that are plugged into the motherboard) and one or more analog and/or mixed signal integrated circuits (ICs) 104 such as clock circuits, driver circuits, etc.

The processor 101 and supporting integrated circuits 102-104 can be viewed as being composed of different regions, where each region receives electrical power through its own dedicated power supply rail (or “supply rail”) having a particular supply voltage and nominal and/or maximum input current draw that is specific to the region's electrical demands.

For example, a processing core 106 within the processor 101 can correspond to a first region having a dedicated supply rail of 0.8 volts (V) and 750 milliamps (mA), an L3 cache 107 within the processor 101 can correspond to a second region having a dedicated supply rail of 1.8V and 1.5 A, an I/O hub 108 within the processor can correspond to a third region having a dedicated supply rail of 3.3V and 2.5 A, an NVM device 103 that is plugged into the motherboard 100 can correspond to a fourth region having a dedicated supply rail of 3.3V and 5.0 A, a certain subset 110 of the motherboard's analog ICs 104 can correspond to a fifth region having a dedicated supply rail of 5.0V and 7.5 A, etc.

The different supply rails for the different regions emanate from different, respective regulator circuits 111-1, 111-2, 111-3, etc. within one or more voltage regulator modules 112. For example, in the example above, one regulator circuit, e.g., regulator 111-2, can provide the 0.8 V and 750 mA supply rail for the processing core region 106 within the processor, another regulator circuit, e.g., regulator 111-3, can provide the 1.8V and 1.5 A supply rail for the L3 cache region 107 within the processor, etc.

A regulator circuit, such as any of regulator circuits 111-1, 111-2, 111-3, is commonly implemented as a power stage circuit that generates a particular supply voltage in accordance with a pulse width modulation signal. The pulse width modulation signal can be generated by a multiphase digital controller (not shown) that is coupled to an external bus, such as a PMBus 113, for enhanced functional input control from, e.g., the motherboard's baseboard management controller 114 (BMC) to the regulator circuit.

A regulator circuit with integrated digital controller as described above, such as regulator 111-1, can also include an enhanced interface 114 between the regulator circuit and the region 115 that regulator circuit 111-1 provides a supply rail for. Such an enhanced interface 114 (e.g., a serial voltage identification (SVID) interface) can implement a mechanism by which intelligence associated with the region 115 tells the regulator circuit 111-1 what the region's supply voltage should be, e.g., during bring-up of the motherboard 100.

Another enhanced interface 116 between a region 115 within the processor 101 and the regulator circuit 111-1 that provides power to the region 115 can include a mechanism for providing telemetry information to the processor 101 that indicates that amount of power being consumed by the motherboard 100 (the “system” or “platform”).

Here, as observed in FIG. 1, the regulator circuits 111 within the one or more voltage regulator modules 112 are designed to step-down a system-level supply voltage (e.g., 12V as observed in FIG. 1) that is provided by a power supply unit (PSU) 117 to their particular, respective supply rail voltage (V_{CC}, V_{CC_X}, V_{CC_Y}, . . . as observed in FIG. 1). The voltage and current provided to the different regions manifest themselves as a total power drawn from the PSU 117 by the regions' respective regulator circuits 111.

The digital controller for a regulator circuit 111-1 having the enhanced system power telemetry interface 116 can be configured to receive information that describes the current being pulled from the PSU 117 (Isys) and the voltage being generated by the PSU 117 (Vsys). From this information, the regulator circuit's digital controller can monitor total power being delivered by the PSU 117 to the system 100, and, report the same to the processor (“Psys”).

In various embodiments, analog-to-digital conversion is performed on the analog Isys signal and the analog Vsys signal. Psys is then calculated digitally from the multiplication of digital Isys and digital Vsys by the regulator's digital controller and passed to the processor through interface 116 as a digital signal. In other embodiments, the analog Isys and analog Vsys signals are multiplied as analog signals to create an analog Psys. An analog-to-digital converter then converts the analog Psys signal to a digital Psys signal that is passed to the processor through interface 116.

Depending on implementation, the digital controller can also be programmed with certain system power thresholds and generate alarms that are sent to the processor through the enhanced system power telemetry interface 116 when the information from the PSU 117 indicates these thresholds have been exceeded or are about to be exceeded (“Psys_CRIT #”).

Such thresholds can include, for example, a first threshold for average system power that is not to be exceeded by the system, a second threshold that if exceeded will cause the processor 101 to implement a first algorithm that attempts to limit system level power spikes (e.g., above the second threshold), and/or, a third threshold that if exceeded will cause the processor 101 to implement a second algorithm that attempts to limit the duty cycle of system level power spikes (e.g., above the third threshold). In further embodiments the digital controller is programmed with an averaging constant for an exponential weighted moving average (EWMA) power calculation that is used to calculate the first threshold described above.

In various embodiments, the regulator circuit 111-1 with the enhanced system power telemetry interface 116 is coupled to the region 115 within the processor that powers the processor's power control unit 118. The processor's power control unit 118 controls (or helps control) the power consumption of the processor and the system 100.

The processor's power control unit 118 is responsible for managing the power consumption of the processor 101 including managing the voltage scaling, frequency scaling and/or clock gating within the processor 101. Here, the power consumption (and performance) of a circuit will decrease as the circuit's supply voltage is lowered and/or as the circuit's clock frequency is lowered. Clock gating is a form of enablement/disablement in which certain circuits within the processor are enabled/disabled by turning the circuit's clocks on/off.

Depending on implementation, the processor's power control unit 118 can apply voltage/frequency scaling and/or clock gating to the respective circuitry that is powered by the different supply rail regions within the processor 101 or even specific circuits within a particular one of the processor's supply rail regions. For voltage scaling, at least in some implementations, the processor's power control unit 118 can cause a regulator circuit's digital controller to change the supply voltage for the region that the regulator circuit provides the supply rail for (e.g., by causing the processor 101 to send a signal to the BMC 114, which, in turn, programs the digital controller through the PMBus 113).

The processor's power control unit 118 typically includes a controller that executes low level firmware 119 to implement various algorithms that effect the voltage/frequency scaling and/or enabling/disabling of various regions and/or components within the processor 101 consistent with the processor's workload and the available power. Additionally, the low level firmware 119 can be written to control or at least influence (e.g., along with the BMC 114) the performance and/or power consumption of the system components that are external to the processor (e.g., the memory 102, the NVM 103 and analog ICs 104).

Thus, the processor 101 executes low level firmware 119 that controls both the processor's power consumption as well as the system's overall power consumption. Here, the system level power consumption telemetry information (Psys) that is provided to the processor through interface 116 can be particularly useful because it informs the processor 101 of any excess power (power budget) that the overall system has available (if Psys is less than a maximum allowed Psys there exists some available power budget).

The processor's low level firmware 119 can also determine (or help determine) whether increasing the performance (and corresponding power consumption) of various internal processor components 106, 107, 108 and/or external system components 102, 103, 104 is worthwhile given the processor's and/or system's workload (and/or other policies such as minimizing energy usage).

The PSU 117 includes a switching converter that switches at a particular frequency f1 to generate the system level DC voltage. As observed at inset 120, the efficiency 123 of the PSU varies as a function of the system's power consumption (the efficiency of the PSU 117 is the amount of power that the PSU 117 delivers to the system 100 normalized by the amount of power consumed by the PSU 117 in order to generate that power, the system current load 121 that is drawn from the PSU 117 can be considered as a direct indication of system power consumption assuming the PSU output voltage is approximately constant). That is, when the PSU is switching at frequency f1 123, there exists a system-level power consumption range 122 where the PSU 117 operates with higher efficiency. The efficiency of the PSU then declines as the system's power consumption increases above this range 122 or falls below this range.

Notably, the PSU 117 also has the capability to change the frequency of the switching of its voltage conversion circuitry to avoid a situation where the PSU operates for extended periods of time with low efficiency. Here, as observed at inset 120, different PSU efficiency curves 123, 124 are exhibited for different converter switching frequencies f1, f2. In the particular example of FIG. 1, a lower converter switching frequency f2 124 exhibits a higher efficiency at lower system power consumptions than a higher converter switching frequency f1 123.

Thus, according to one approach, the PSU's voltage conversion circuitry is capable of switching at more than one frequency, and, the PSU 117 further includes software, firmware, and/or hardware, or any combination of two or more of these 151, that is designed to change the switching frequency of the PSU's converter circuitry based on feedback information that is provided to the PSU 117 from the system 100.

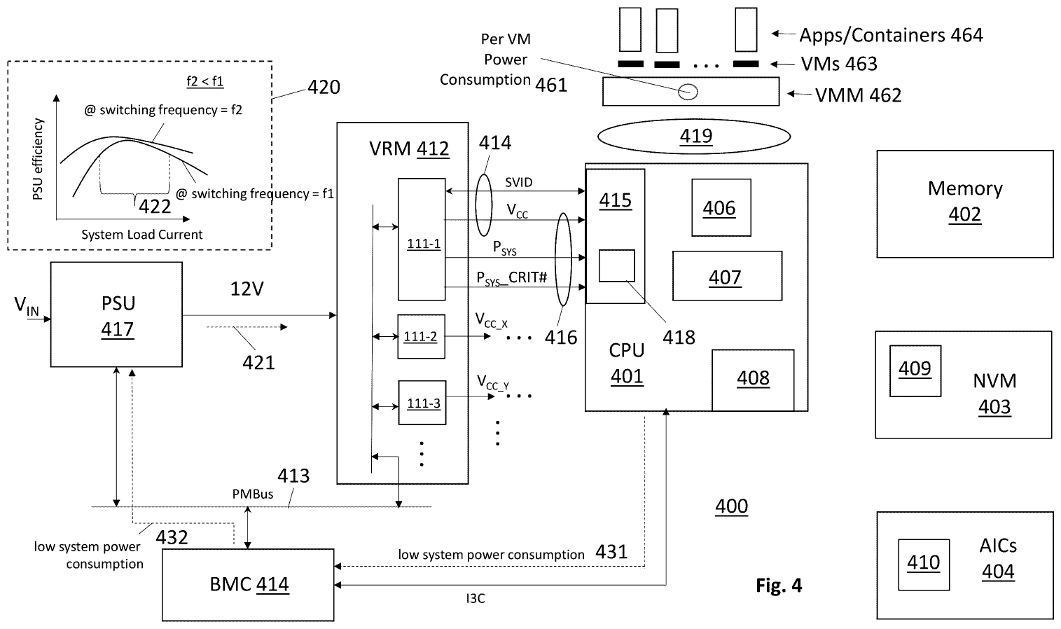

In one approach of FIG. 1, the processor's low level firmware 119 monitors the power being consumed by the system by monitoring Psys through enhanced interface 116 and/or other parameters that are indicative of system level power consumption (such as “per VM” power consumption as described in more detail further below with respect to FIG. 4). If the processor's low level firmware 119 (or other software such as a virtual machine monitor, operating system and/or application software) determines that the power being consumed by the system is below the range 122 of system power at which the PSU 117 operates with higher efficiency when the PSU's converter circuitry is switching at a first (nominal) frequency f1 123, the processor 201 informs 131 the BMC 114 of this determination.

In various embodiments, the BMC 114 includes one or more processors and/or controllers that execute software and/or firmware that controls various components on the motherboard 100 including the PSU 117. In various embodiments the BMC software and/or firmware offers at least one API to the processor 101 through which the processor's low level firmware 119 (and/or higher level software such as a virtual machine monitor and/or operating system instance) informs the BMC 114 of the system's low power consumption level.

The BMC 114, in response, informs 132 the PSU 117 (e.g., by writing to registers on the PSU 117 via the PMBus 113) that the system level power consumption has fallen below the range 122 at which the PSU 117 operates with higher efficiency at the higher switching frequency f1. The PSU 117, in response, changes the switching frequency of its voltage conversion activity from f1 to f2 to improve the PSU's efficiency at the lower system level power consumption.

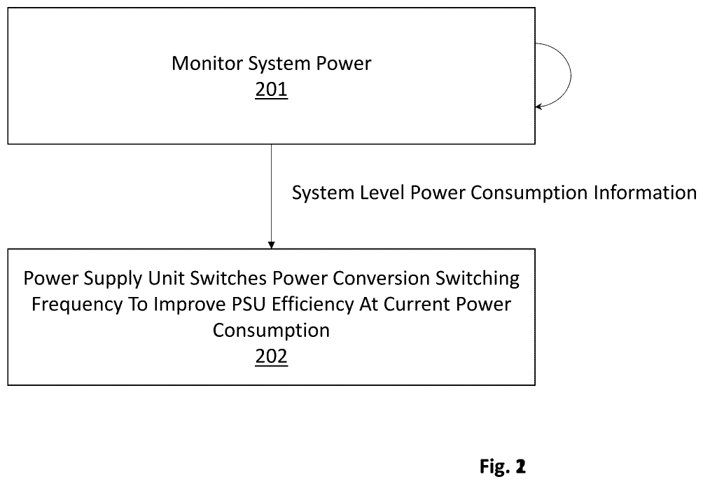

Thus, as observed in FIG. 2, the system includes a feedback mechanism by which system power is monitored 201. The system power information is fedback to the PSU. The PSU switches 202 it's power supply conversion frequency if there exists a higher PSU efficiency at a switching frequency that is different than the current switching frequency.

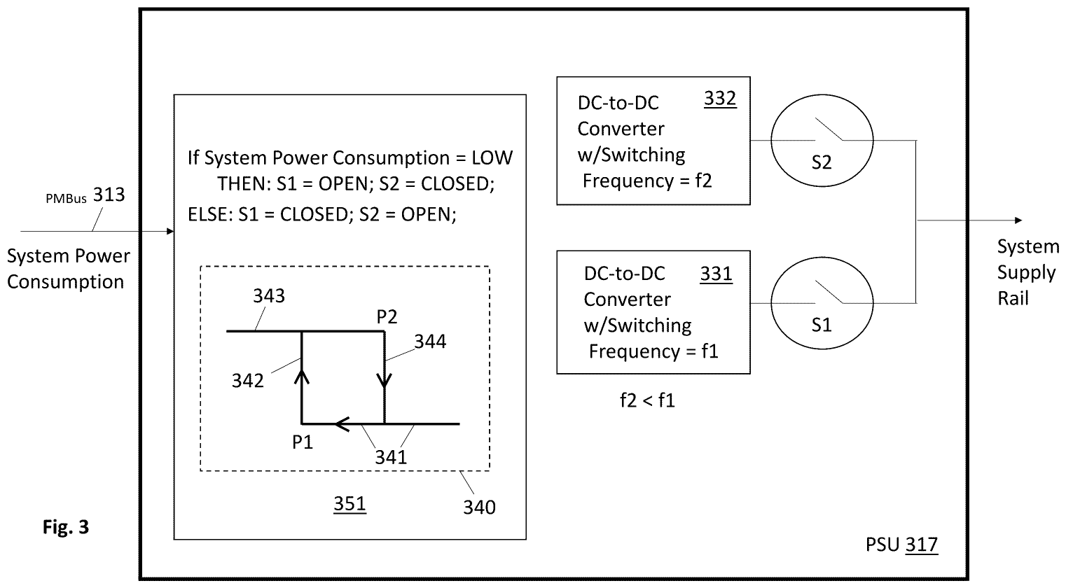

Owing to the precision at which the electrical characteristics of a switching converter's components (e.g., capacitors, resistors, inductors) are designed to have in order to support switching at a particular frequency, according to one embodiment, as observed in FIG. 3, the PSU 317 includes first and second switching converter circuits 331, 332: 1) a first nominal converter circuit 331 that switches at a first, nominal switching frequency f1; and, 2) a second converter circuit 332 that switches at a second switching frequency f2 that is lower than the first switching frequency f1 (f2<f1).

Here, in various embodiments, the PSU 317 is designed to nominally operate with the first converter circuit 331 being enabled and switching at the first switching frequency f1. In this state, the second converter circuit 332 is disabled. As described above with respect to inset 120 of FIG. 1, however, PSU efficiency can be higher at lower system power consumption levels with lower conversion switching frequency f2. Thus, if the system is consuming power below a range 122 at which the first converter circuit 331 operates with higher efficiency, the PSU 317 will disable the first converter circuit 331 and enable the second converter circuit 332 thereby improving PSU efficiency at the lower system power consumption level.

As observed at inset 340 in FIG. 3, hysteresis can be designed into the functionality of the PSU 317 that establishes the enabling of one of the converter circuits 331, 332 and the disabling of the other of the converter circuits 331, 332. Specifically, nominally the PSU 317 operates with the first converter circuit operating 331 at the first switching frequency f1 along leg 341 of the hysteresis curve while the second converter circuit 332 is disabled.

If the power consumption of the system falls below a level P1 at which the first converter circuit 331 operates at higher efficiency, the PSU 317 improves its efficiency by enabling the second converter circuit 332 that switches at a second, lower frequency and disabling the first converter circuit 331. This transition corresponds to leg 342 of the hysteresis curve. Assuming the power consumption of the system remains at a lower level, the PSU continues to operate along leg 343 of the hysteresis curve with the second converter circuit 332 being enabled and the first converter circuit 331 being disabled.

If the power consumption of the system eventually rises beyond P1, the operation of the PSU moves to the right along leg 343 of the hysteresis curve. Notably, the PSU 317 continues to operate with the second converter circuit enabled 332 and the first converter circuit 331 disabled even if the system level power consumption exceeds the level P1 at which the PSU disabled 342 the first converter circuit 331 and enabled the second converter circuit 332. If the power consumption of the system continues to rise beyond level P1 and then reaches higher level P2, the PSU 317 transitions 344 back to its nominal state along leg 341 in which the second converter circuit 332 is disabled and the first converter circuit 331 is enabled.

Separating the system level power consumptions P1, P2 at which the transitions 342, 344 occur prevents the PSU 317 from thrashing the enablement/disablement of its converter circuits 331, 332 if the system continually consumes power approximately at the level P1 at which transition 342 occurs.

The PSU 317 could also be designed to include more than two converter circuits to further improve PSU efficiency, e.g., at even lower system power consumption levels. For example, a third converter circuit could be integrated into the PSU that switches at an even lower switching frequency than the second converter circuit 332. If the power consumption of the system falls to a level at which PSU efficiency falls below the second converter's higher efficiency range, the PSU enables the third converter circuit (and disables the first and second converter circuits 331, 332) to maintain the PSU's efficiency above that at which the first and second converter circuits 331, 332 could achieve at the even lower system power consumption.

In still other embodiments, a single switching conversion circuit is designed into the PSU 317 that has the ability to switch at two different frequencies f1 and f2. For example, such a circuit could include variable/programmable resistive, capacitive and/or inductive elements any/all of whose corresponding values change when conversion switching frequencies are changed. For example, a resistor element within the conversion circuit could have a first resistance value R1 when switching at a first frequency 11 and a second resistance value R2 when switching at a second frequency f2. Here, the PSU's logic 351 (e.g., a controller) could configure these changes when changing the switching frequency of the PSU 317. Alternatively or in combination, to the extent switching frequency is determined from a clock frequency, the PSU logic 351 (e.g., a controller) could change the frequency of a clock that is provided to the conversion circuit to change the circuit's conversion switching frequency.

Returning back to FIG. 1, in various alternate embodiments, rather than the processor's firmware 119 determining that the system's power consumption has fallen below a level at which the PSU 117 operates with high efficiency, the determination is made by a virtual machine monitor (VMM) and/or operating system (OS) (described further below) in conjunction with or at the exclusion of the processor's firmware 119.

In still other embodiments, the determination that the system's power consumption has fallen below a level at which the PSU 117 operates with high efficiency is made by the BMC 114 and/or the PSU 117. In this case, the processor 101 and/or its firmware 119 monitors power consumption parameters of the system and reports these to the BMC 114. The BMC 114 then determines that the PSU switching frequency needs to change and informs the PSU 117 of the same, or, the BMC 114 forwards the system power consumption information to the PSU 117 (the BMC can also send other system power parameters to the PSU 117 that the BMC 114 specifically tracks (such as memory 102 power consumption, NVM 103 power consumption, and/or analog IC power 104 consumption)).

In the case where the PSU 117, 317 is informed of the system's power consumption rather than being explicitly told to switch conversion frequencies, the PSU 117, 317 includes the logic 151, 351 to determine when switching conversion frequencies is appropriate.

For example, in one embodiment, the PSU logic 151, 351 includes a look-up table (LUT) where an entry in the table correlates a specific system power consumption level to an appropriate switching frequency and/or converter circuit to use for that system power consumption level (different table entries identify different system power consumption levels and corresponding switching frequency/circuit). Thus, the PSU 117, 317 receives the system power consumption information from the BMC 114 and then uses the information as a look-up parameter into the LUT to understand which frequency/circuit should be used. The table entries can be recorded in non volatile memory within the PSU 117, 317 or that is coupled to the PSU 11, 317.

Notably, PSU logic 151, 351 described above can be implemented in software and/or firmware that executes on a processor or controller that is embedded within the PSU 317, in dedicated hardware (e.g., state machine logic circuitry) that is integrated within the PSU 317 or a combination of hardware and software and/or firmware.

In various embodiments, the PSU 117, 317 includes functionality that exposes on the PMBus 113, 313 to the BMC 114 that it has the capability to switch conversion frequency. The PSU 117, 317 can further expose on the PMBus 113, 313 to the BMC 114 that is has the ability to determine the appropriate conversion frequency for a particular system power consumption level. The BMC 114 can receive this information, e.g., during bring-up of the system, to enable the appropriate feedback of information to the PSU 117, 317 to enable switching frequency changes within the PSU 117, 317 according to any of the mechanisms described above.

According to at least some embodiments, the system power consumption level is reported by the BMC 114 to the PSU 117, 317 as a scale. For example, the BMC 114 expresses the system's power consumption level as a 4 bit data structure that can have values between 0 and 9 inclusive. Here, 0 corresponds to a minimum system power consumption level and 9 corresponds to a maximum system power consumption level.

The PSU's LUT can be constructed so that, e.g., system power consumption levels of 4 or higher cause the PSU to convert at the higher (nominal) switching frequency f1, whereas, system power consumption levels of 3 or lower cause the PSU to convert at a lower switching frequency f2 than the nominal frequency f1. Hysteresis can be handled by the BMC 114 or PSU 117, 317 to prevent thrashing between two neighboring scaled values if the system's power consumption continually operates in a region near the boundary between the two neighboring scaled values where the decision to change frequency is marked (e.g., the higher frequency f1 will be enabled from the lower frequency f2 only if a repeated sequence of N consecutive higher power level values is observed (e.g., ten consecutive “4s” or higher are observed)).

Certain embodiments can also be designed so that the processor 101 sends system power level information to the PSU 117, 317 directly rather than through the BMC 114. For example, if the processor 101 includes a PMBus, the processor 101 can be coupled (e.g., directly or bridged) to the PMBus 113 that the PSU 117 is coupled to.

Further embodiments can include the processor 101 and/or its firmware 119 incorporating other power consumption parameters in conjunction with, or instead of, the Psys parameter. Here, as discussed above, the Psys parameter is a system level power consumption metric that is determined in hardware. Additionally or alternatively, as indicated above, software metrics can be used to gauge system level power consumption.

For example, as observed in FIG. 4, per VM power consumption 461 can be incorporated into a metric that measures (or helps measure) system level power consumption. In various embodiments, the software platform that executes on the processor includes a virtual machine monitor (VMM) 462, or hypervisor, that instantiates multiple virtual machines 463 (VMs). Operating system (OS) instances respectively execute on the VMs and applications 464 execute on the OS instances. Alternatively or combined, container engines (e.g., Kubernetes container engines) respectively execute on the OS instances. The container engines provide virtualized OS instances and containers 464 respectively execute on the virtualized OS instances. The containers 464 provide isolated execution environment for a suite of applications which can include applications for micro-services.

Notably, each virtual machine is typically allocated a software thread on the processor 401. The processor 401 includes multiple instruction execution pipelines each of which executes a hardware thread (e.g., the processor 401 includes X CPU processing cores where each CPU processing core includes Y instruction execution pipelines). A single hardware thread can concurrently execute multiple software threads (e.g., by context switching the respective states of the software threads in/out of the pipeline's hardware thread). Thus, many VMs can be concurrently executed on the processor (e.g., if the Y instruction execution pipelines can each support Z software threads, the processor 401 can support XYZ concurrent VMs).

The applications and/or containers 464 that execute on the VMs 463 can have a significant influence on the power consumption of the system (their execution corresponds to the “work” being performed by the system). Thus, the system's power consumption generally will increase as the number of VMs 463 and/or the number of applications/containers 464 that are executing on the processor 401 increase. Likewise, the system's power consumption will generally decrease as the number of VMs 463 and/or applications/containers 464 decrease.

Moreover, the applications/containers 464 that execute upon the VMs 463 have their own unique power consumption “profile”. For example, certain applications will use memory 402 more while other applications will use memory 402 less, other applications will use NVM 403 more while other applications will use NVM 403 less, etc.

These characteristics can be synthesized to a learned power consumption associated with a VM upon which a particular application, set of applications and/or container 464 executes. For example, a processor's power control unit 418 and supporting firmware 419 may recognize a need to increase the supply voltage and/or clock frequency of a hardware thread that supports execution of a VM 463 that is allocated to a particular application, set of applications and/or container 464. The change in the processor's power consumption in response to its execution of the VM can be linked with additional changes in system power consumption that are caused by the VM's application(s)/containers usage of system level resources such as memory 402, NVM 403, etc.

By observing and learning the power consumption profiles of specific application(s)/containers 464, the power consumption of the processor 401 and system 400 can be predicted when a VM is newly instantiated to support execution of the specific application(s)/containers 464. Thus, per VM power consumption metrics (e.g., as calculated by functionality 461 within a VMM 462, low level firmware 419 and/or supporting hardware in the processor 401 that monitors power consumption on a software thread by software thread basis) can be used not only to measure current power consumption levels but future power consumption levels as well.

As such, in various embodiments, a hardware based power consumption metric (e.g., Psys) is combined with a software based power consumption metric (e.g., per VM power consumption) to generate a power consumption metric that reflects not only the system's current power consumption level but also the system's future power consumption level.

For example, a particular metric could be calculated as a weighted sum of Psys and the number of currently active VMs 463 where each VM is assumed to consume the average power consumption for all VMs observed in the system thus far. The weights could be adjusted to reflect current power more heavily (by weighing Psys more heavily) or future power more heavily (by weighing average VM power more heavily). Another metric could be calculated as a weighted sum of Psys and the average observed power for each VM based on each VM's particular application, set of applications and/or container and the learned power consumptions of the application/applications/container.

Although embodiments above have stressed implementations where the PSU has improved efficiency at low system power consumption levels with lower conversion frequency, to the extent other PSUs exist in which improved efficiency at low system power consumption levels is achieved with higher conversion frequency, the teachings above can be readily applied to such PSUs so that conversion frequency is increased (rather than decreased) when system level power consumption is low. Depending on implementation, the PSU can be a DC-to-DC converter, an AC-to-DC converter, etc.

The processor 101, 401 described above with respect to FIGS. 1 and 4 can be a general purpose processor such as a semiconductor chip having multiple general purpose processing cores (e.g., multiple CPU cores). In other embodiments the processor 101, 401 is a graphics processor (GPU) including a graphics processor having multiple graphics processing cores. In still other embodiments the processor 101, 401 is an accelerator that performs one or more computationally intensive functions (e.g., neural network processing, artificial intelligence machine learning, artificial intelligence inferencing, encoding and/or decoding, compression and/or decompression, etc.) in hardwired logic circuitry designed to perform the function(s) (e.g., as application specific integrate circuit (ASIC) blocks). In still yet other embodiments the processor 101, 401 is an infrastructure processing unit (IPU), described in more detail further below.

Although the systems 100, 400 of FIGS. 1 and 4 only depict one processor 101, 401 on the system 100, 400, other embodiments can include multiple processors on a single system including processors of only a same type (e.g., general purpose, GPU, accelerator, IPU) or of different types.

Although embodiments above have stressed that the processor 101, 401 and/or a BMC 114, 414 receive and/or process system level power consumption information for purposes of causing the PSU 117, 417 to modulate its conversion switching frequency, in other embodiments, these components are partially or wholly left out of the feedback loop to the PSU 117, 417. For example, after the above described digital Psys signal is created, it can be fed back to the PSU 117, 417 directly. This can be done with the Psys signal also being sent to the processor 101, 401, or not being sent to the processor 101, 401. Upon receipt of the Psys signal, the logic 151, 351 within the PSU determines whether the conversion switching frequency should be changed or not according to the principles described above.

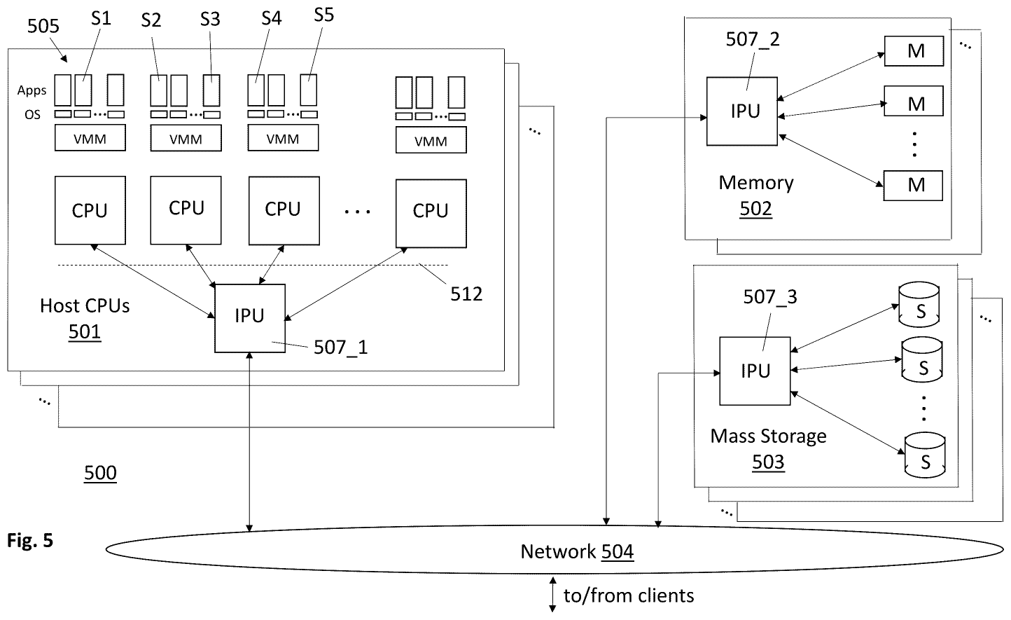

FIG. 5 shows a new, emerging data center environment in which “infrastructure” tasks are offloaded from traditional general purpose “host” CPUs (where application software programs are executed) to an infrastructure processing unit (IPU), edge processing unit (EPU), or data processing unit (DPU) any/all of which are hereafter referred to as an IPU.

Networked based computer services, such as those provided by cloud services and/or large enterprise data centers, commonly execute application software programs for remote clients. Here, the application software programs typically execute a specific (e.g., “business”) end-function (e.g., customer servicing, purchasing, supply-chain management, email, etc.). Remote clients invoke/use these applications through temporary network sessions/connections that are established by the data center between the clients and the applications. A recent trend is to strip down the functionality of at least some of the applications into more finer grained, atomic functions (“micro-services”) that are called by client programs as needed. Micro-services typically strive to charge the client/customers based on their actual usage (function call invocations) of a micro-service application.

In order to support the network sessions and/or the applications' functionality, however, certain underlying computationally intensive and/or trafficking intensive functions (“infrastructure” functions) are performed.

Examples of infrastructure functions include routing layer functions (e.g., IP routing), transport layer protocol functions (e.g., TCP), encryption/decryption for secure network connections, compression/decompression for smaller footprint data storage and/or network communications, virtual networking between clients and applications and/or between applications, packet processing, ingress/egress queuing of the networking traffic between clients and applications and/or between applications, ingress/egress queueing of the command/response traffic between the applications and mass storage devices, error checking (including checksum calculations to ensure data integrity), distributed computing remote memory access functions, etc.

Traditionally, these infrastructure functions have been performed by the CPU units “beneath” their end-function applications. However, the intensity of the infrastructure functions has begun to affect the ability of the CPUs to perform their end-function applications in a timely manner relative to the expectations of the clients, and/or, perform their end-functions in a power efficient manner relative to the expectations of data center operators.

As such, as observed in FIG. 5, the infrastructure functions are being migrated to an infrastructure processing unit (IPU) 507. FIG. 5 depicts an exemplary data center environment 500 that integrates IPUs 507 to offload infrastructure functions from the host CPUs 501 as described above.

As observed in FIG. 5, the exemplary data center environment 500 includes pools 501 of CPU units that execute the end-function application software programs 505 that are typically invoked by remotely calling clients. The data center also includes separate memory pools 502 and mass storage pools 503 to assist the executing applications. The CPU, memory storage and mass storage pools 501, 502, 503 are respectively coupled by one or more networks 504.

Notably, each pool 501, 502, 503 has an IPU 507_1, 507_2, 507_3 on its front end or network side. Here, each IPU 507 performs pre-configured infrastructure functions on the inbound (request) packets it receives from the network 504 before delivering the requests to its respective pool's end function (e.g., executing application software in the case of the CPU pool 501, memory in the case of memory pool 502 and storage in the case of mass storage pool 503).

As the end functions send certain communications into the network 504, the IPU 507 performs pre-configured infrastructure functions on the outbound communications before transmitting them into the network 504. The communication 512 between the IPU 507_1 and the CPUs in the CPU pool 501 can transpire through a network (e.g., a multi-nodal hop Ethernet network) and/or more direct channels (e.g., point-to-point links) such as Compute Express Link (CXL), Advanced Extensible Interface (AXI), Open Coherent Accelerator Processor Interface (OpenCAPI), Gen-Z, etc.

Depending on implementation, one or more CPU pools 501, memory pools 502, mass storage pools 503 and network 504 can exist within a single chassis, e.g., as a traditional rack mounted computing system (e.g., server computer). In a disaggregated computing system implementation, one or more CPU pools 501, memory pools 502, and mass storage pools 503 are separate rack mountable units (e.g., rack mountable CPU units, rack mountable memory units (M), rack mountable mass storage units (S).

In various embodiments, the software platform on which the applications 505 are executed include a virtual machine monitor (VMM), or hypervisor, that instantiates multiple virtual machines (VMs). Operating system (OS) instances respectively execute on the VMs and the applications execute on the OS instances. Alternatively or combined, container engines (e.g., Kubernetes container engines) respectively execute on the OS instances. The container engines provide virtualized OS instances and containers respectively execute on the virtualized OS instances. The containers provide isolated execution environment for a suite of applications which can include applications for micro-services.

Notably, the motherboard systems 100, 400 described at length above with respect to FIGS. 1,2, 3 and 4 can be readily integrated into the CPU pool 501 (if the processor 101, 401 is a general purpose processor) or an accelerator pool (if the processor 101, 401 is an GPU or accelerator) or as a motherboard system for an IPU. Alternatively, the motherboard systems 100, 400 described at length above with respect to FIGS. 1, 2, 3 and 4 can be a motherboard system for a more traditional computer/server in which a general purpose processor, main memory, non volatile storage and any accelerators are integrated upon and/or plugged into a main motherboard and packaged in a same chassis.

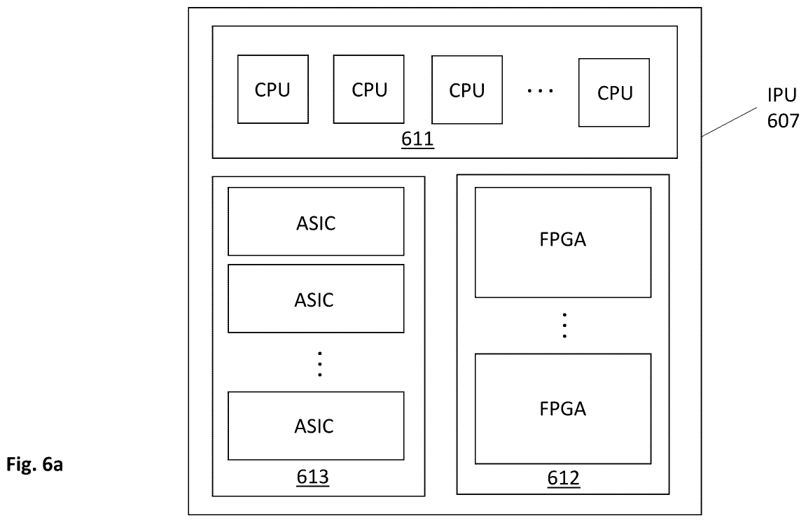

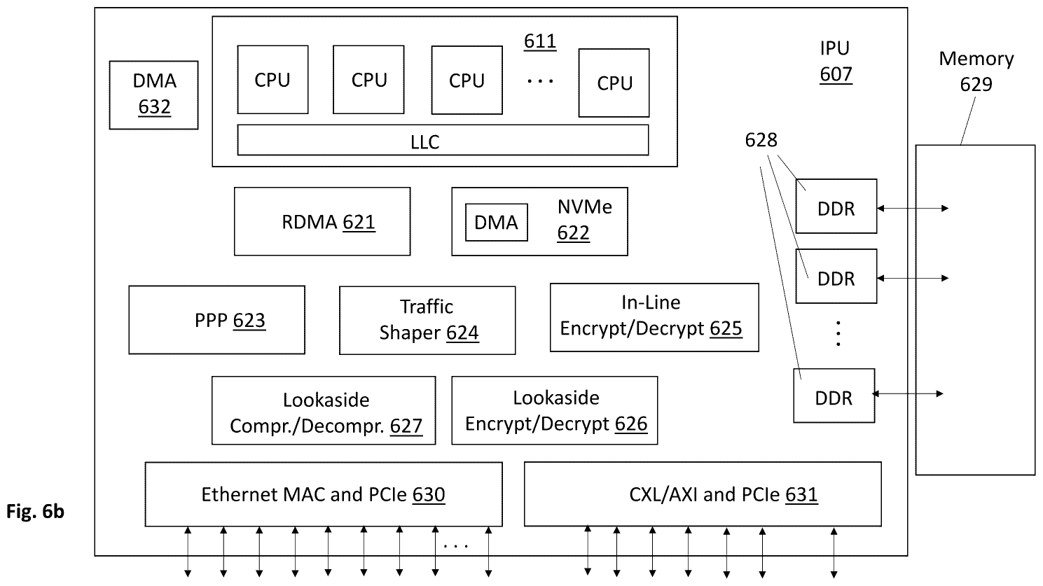

FIG. 6a shows an exemplary IPU 607. As observed in FIG. 6a the IPU 607 includes a plurality of general purpose processing cores 611, one or more field programmable gate arrays (FPGAs) 612, and/or, one or more acceleration hardware (ASIC) blocks 613. An IPU typically has at least one associated machine readable medium to store software that is to execute on the processing cores 611 and firmware to program the FPGAs (if present) so that the processing cores 611 and FPGAs 612 (if present) can perform their intended functions.

The IPU 607 can be implemented with: 1) e.g., a single silicon chip that integrates any/all of cores 611, FPGAs 612, ASIC blocks 613 on the same chip; 2) a single silicon chip package that integrates any/all of cores 611, FPGAs 612, ASIC blocks 613 on more than chip within the chip package; and/or, 3) e.g., a rack mountable system having multiple semiconductor chip packages mounted on a printed circuit board (PCB) where any/all of cores 611, FPGAs 612, ASIC blocks 613 are integrated on the respective semiconductor chips within the multiple chip packages.

The processing cores 611, FPGAs 612 and ASIC blocks 613 represent different tradeoffs between versatility/programmability, computational performance, and power consumption. Generally, a task can be performed faster in an ASIC block and with minimal power consumption, however, an ASIC block is a fixed function unit that can only perform the functions its electronic circuitry has been specifically designed to perform.

The general purpose processing cores 611, by contrast, will perform their tasks slower and with more power consumption but can be programmed to perform a wide variety of different functions (via the execution of software programs). Here, the general purpose processing cores can be complex instruction set (CISC) or reduced instruction set (RISC) CPUs or a combination of CISC and RISC processors.

The FPGA(s) 612 provide for more programming capability than an ASIC block but less programming capability than the general purpose cores 611, while, at the same time, providing for more processing performance capability than the general purpose cores 611 but less than processing performing capability than an ASIC block.

FIG. 6b shows a more specific embodiment of an IPU 607. The particular IPU 607 of FIG. 6b does not include any FPGA blocks. As observed in FIG. 6b the IPU 607 includes a plurality of general purpose cores 611 and a last level caching layer for the general purpose cores 611. The IPU 607 also includes a number of hardware ASIC acceleration blocks including: 1) an RDMA acceleration ASIC block 621 that performs RDMA protocol operations in hardware; 2) an NVMe acceleration ASIC block 622 that performs NVMe protocol operations in hardware; 3) a packet processing pipeline ASIC block 623 that parses ingress packet header content, e.g., to assign flows to the ingress packets, perform network address translation, etc.; 4) a traffic shaper 624 to assign ingress packets to appropriate queues for subsequent processing by the IPU 607; 5) an in-line cryptographic ASIC block 625 that performs decryption on ingress packets and encryption on egress packets; 6) a lookaside cryptographic ASIC block 626 that performs encryption/decryption on blocks of data, e.g., as requested by a host CPU 501; 7) a lookaside compression ASIC block 627 that performs compression/decompression on blocks of data, e.g., as requested by a host CPU 501; 8) checksum/cyclic-redundancy-check (CRC) calculations (e.g., for NVMe/TCP data digests and/or NVMe DIF/DIX data integrity); 9) thread local storage (TLS) processes; etc.

So constructed/configured, the IPU can be used to perform routing functions between endpoints within a same pool (e.g., between different host CPUs within CPU pool 501) and/or routing within the network 504. In the case of the latter, the boundary between the network 504 and the IPU's pool can reside within the IPU, and/or, the IPU is deemed a gateway edge of the network 504.

The IPU 607 also includes multiple memory channel interfaces 628 to couple to external memory 629 that is used to store instructions for the general purpose cores 611 and input/output data for the IPU cores 611 and each of the ASIC blocks 621-626. The IPU includes multiple PCIe physical interfaces and an Ethernet Media Access Control block 630, and/or more direct channel interfaces (e.g., CXL and or AXI over PCIe) 631, to support communication to/from the IPU 607. The IPU 607 also includes a DMA ASIC block 632 to effect direct memory access transfers with, e.g., a memory pool 502, local memory of the host CPUs in a CPU pool 501, etc. As mentioned above, the IPU 607 can be a semiconductor chip, a plurality of semiconductor chips integrated within a same chip package, a plurality of semiconductor chips integrated in multiple chip packages integrated on a same module or card, etc.

Embodiments of the invention may include various processes as set forth above. The processes may be embodied in program code (e.g., machine-executable instructions). The program code, when processed, causes a general-purpose or special-purpose processor to perform the program code's processes. Alternatively, these processes may be performed by specific/custom hardware components that contain hard wired interconnected logic circuitry (e.g., application specific integrated circuit (ASIC) logic circuitry) or programmable logic circuitry (e.g., field programmable gate array (FPGA) logic circuitry, programmable logic device (PLD) logic circuitry) for performing the processes, or by any combination of program code and logic circuitry.

Elements of the present invention may also be provided as a machine-readable storage medium for storing the program code. The machine-readable medium can include, but is not limited to, floppy diskettes, optical disks, CD-ROMs, and magneto-optical disks, FLASH memory, ROMs, RAMs, EPROMs, EEPROMs, magnetic or optical cards or other type of media/machine-readable medium suitable for storing electronic instructions.

In the foregoing specification, the invention has been described with reference to specific exemplary embodiments thereof. It will, however, be evident that various modifications and changes may be made thereto without departing from the broader spirit and scope of the invention as set forth in the appended claims. The specification and drawings are, accordingly, to be regarded in an illustrative rather than a restrictive sense.

Some possible embodiments include the following examples.

Example 1. A method that includes receiving system level power information and causing a power supply unit's voltage conversion switching frequency to change based on the system level power information. The power supply unit supplies power to a system that includes at least a processor and a memory. The system level power information describes power consumed by at least the processor and the memory.

Example 2. The method of Example 1 where the method is performed by the processor.

Example 3. The method of Example 2 wherein the system level power information includes a Psys signal generated by a voltage regulator that is coupled to the processor.

Example 4. The method of Example 1 wherein the method is performed by a baseboard management controller of the system.

Example 5. The method of Example 4 where the system level power information is determined at least in part from a Psys signal that was received by the processor from a voltage regulator, and wherein, the system level power information was sent by the processor to the baseboard management controller.

Example 6. The method of Example 1 wherein the method is performed by the power supply unit.

Example 7. The method of Examples 1, 2 or 3 wherein the method is performed by software executing on a processor of the system, wherein, the system level power information includes a per virtual machine power consumption metric determined from one or more virtual machines that are executing on the processor.

Example 8. A method that includes sending system level power information to a recipient to cause a power supply unit's voltage conversion switching frequency to change based on the system level power information. The power supply unit supplies power to a system that includes at least a processor and a memory. The system level power information describes power consumed by at least the processor and the memory.

Example 9. The method of Example 8 where the method is performed by the processor.

Example 10. The method of Examples 8 or 9 where the system level power information is based at least in part upon a Psys signal generated by a voltage regulator that is coupled to the processor.

Example 11. The method of Example 8 where the method is performed by a baseboard management controller of the system.

Example 12. The method of Examples 8 or 9 where the system level power information is determined at least in part from a Psys signal that was received by the processor from a voltage regulator, and wherein, the system level power information was sent by the processor to the baseboard management controller.

Example 13. The method of Example 8 wherein the method is performed by a voltage regulator module, the recipient is the power supply unit, and system level power information comprises a Psys signal.

Example 14. The method of Example 8 wherein the system level power information is based at least in part on a per virtual machine power consumption metric determined from one or more virtual machines that are executing on the processor.

Example 15. A system that includes a power supply unit that is able to perform voltage conversion at more than one switching frequency. The system includes a processor. The system includes a memory. The system includes a component to send system level power information to the power supply unit to cause the power supply unit to change the switching frequency based on the system level power information. The power supply unit supplies power to the processor, the memory and the component. The system level power information describes power consumed by at least by the processor, the memory and the component.

Example 16. The system of Example 15 wherein the component is the processor.

Example 17. The system of Example 15 wherein the component is a baseboard management controller.

Example 18. The system of Example 15 wherein the component is a voltage regulator module.

Example 19. The system of Example 15 wherein the system includes a voltage regulator module and the system level power information is derived at least in part from a Psys signal that is generated by the voltage regulator module.

Example 20. The system of Example 15 wherein the system level power information is derived at least in part from a per virtual machine power consumption metric that describes power consumed by the processor as a consequence of the processor's execution of one or more virtual machines.

1. A method, comprising:
receiving system level power information; and,
causing a power supply unit's voltage conversion switching frequency to change based on the system level power information, wherein, the power supply unit supplies power to a system that includes at least a processor and a memory, and wherein, the system level power information describes power consumed by at least the processor and the memory.

2. The method of claim 1 wherein the method is performed by a processor of the system.

3. The method of claim 2 wherein the system level power information includes a Psys signal generated by a voltage regulator that is coupled to the processor.

4. The method of claim 1 wherein the method is performed by a baseboard management controller of the system.

5. The method of claim 4 wherein the system level power information is determined at least in part from a Psys signal that was received by the processor from a voltage regulator, and wherein, the system level power information was sent by the processor to the baseboard management controller.

6. The method of claim 1 wherein the method is performed by the power supply unit.

7. The method of claim 1 wherein the method is performed by software executing on the processor, wherein, the system level power information includes a per virtual machine power consumption metric determined from one or more virtual machines that are executing on the processor.

8. A method, comprising:
sending system level power information to a recipient to cause a power supply unit's voltage conversion switching frequency to change based on the system level power information, wherein, the power supply unit supplies power to a system that includes at least a processor and a memory, and wherein, the system level power information describes power consumed by at least the processor and the memory.

9. The method of claim 8 wherein the method is performed by the processor.

10. The method of claim 9 wherein the system level power information is based at least in part upon a Psys signal generated by a voltage regulator that is coupled to the processor.

11. The method of claim 8 wherein the method is performed by a baseboard management controller of the system.

12. The method of claim 11 wherein the system level power information is determined at least in part from a Psys signal that was received by a processor from a voltage regulator, and wherein, the system level power information was sent by the processor to the baseboard management controller.

13. The method of claim 8 wherein the method is performed by a voltage regulator module, the recipient is the power supply unit, and system level power information comprises a Psys signal.

14. The method of claim 8 wherein the system level power information is based at least in part on a per virtual machine power consumption metric determined from one or more virtual machines that are executing on the processor.

15. A system, comprising:
a power supply unit that is able to perform voltage conversion at more than one switching frequency;
a processor;
a memory; and,
a component to send system level power information to the power supply unit to cause the power supply unit to change the switching frequency based on the system level power information, wherein, the power supply unit supplies power to the processor, the memory and the component, and wherein, the system level power information describes power consumed by at least by the processor, the memory and the component.

16. The system of claim 15 wherein the component is the processor.

17. The system of claim 15 wherein the component is a baseboard management controller.

18. The system of claim 15 wherein the component is a voltage regulator module.

19. The system of claim 15 wherein the system comprises a voltage regulator module and the system level power information is derived at least in part from a Psys signal that is generated by the voltage regulator module.

20. The system of claim 15 wherein the system level power information is derived at least in part from a per virtual machine power consumption metric that describes power consumed by the processor as a consequence of the processor's execution of one or more virtual machines.
